(19) United States
(12) Patent Application Publication
(10) Pub. No.: US 2013/0108072 A1
(43) Pub. Date: May 2, 2013

(54) Wireless Device for Receiving and Forwarding an Audio Signal

(71) Applicant: Add-On Technology Co., Ltd., Taipei (TW)

(72) Inventor: Chi-Liang Chen, Lu Chu Hsiang (TW)

(73) Assignee: ADD-ON TECHNOLOGY CO., LTD., Taipei (TW)

(21) Appl. No.: 13/657,257

(22) Filed: Oct. 22, 2012

(30) Foreign Application Priority Data
Oct. 27, 2011 (IT) TO2011A000974

(51) Int. Cl. H04B 3/00

(52) U.S. Cl. 381/77

(57) ABSTRACT

A wireless device (8a, 8b) for receiving and forwarding an audio signal includes: an antenna (12a, 12b) for receiving the audio signal from a source (2); a circuit (14a, 14b) for receiving and processing the received audio signal; and a jack audio (9a, 9b) for providing the processed audio signal to a sound system (6a, 6b). The jack audio (9a, 9b) includes at least one contact terminal (16a, 18a, 16b, 18b) configured for receiving electrical power from the audio system (6a, 6b) and to provide the electrical power to the circuit (14a, 14b).

### CROSS-REFERENCE TO RELATED APPLICATIONS

This application claims priority to Italian Application No. TO2011A000974, filed Oct. 27, 2011, which application is incorporated herein by specific reference in its entirety.

### BACKGROUND OF THE INVENTION

1. The Field of the Invention

The present invention is related to a wireless device for receiving and forwarding an audio signal.

2. The Relevant Technology

Many sound systems are provided with standard input/output interfaces for receiving and/or providing audio signals. A very common interface is a jack audio like the jack audio 3.5 mm or other similar.

These jacks audio are used to provide audio signals from an audio source to an equipment comprising sound emitting elements such as sound speakers and the like. Typically, a conventional jack audio comprises three contact terminals: one for an electrical reference or ground and one for each audio channel.

The sound emitting elements are often bundled with sound acquisition elements, such as a microphone. This is the typical case of headsets used in conjunction with apparatuses of cellular telephone communication. In such configurations, the jack audio comprises an additional fourth terminal exclusively used for providing an audio signal to the microphone.

At the state of the art, wireless networks are widely available and sound systems and audio sources are distributed over several locations. Yet, many sound systems require a specific wired connection for receiving audio signals.

### SUMMARY OF THE INVENTION

The present invention aims at improving the distribution of audio signals from a source to sound systems taking advantage of the existing infrastructure.

More precisely, the invention relates to a wireless device for receiving and forwarding an audio signal comprising an antenna for receiving the audio signal from a source, a circuit for processing said received audio signal; and a jack audio for providing the received processed audio signal to a sound system. Advantageously, said audio jack comprises at least a contact terminal configured to receive electrical power from said sound system and to provide said electrical power to the receiving and processing circuit.

Conveniently, the device further comprises a memory for storing a unique identification information (ID) and said antenna and processing circuit are further adapted for transmitting said unique identification information (ID) to said source.

In a specific embodiment, said processing circuit is further adapted for processing only audio signals received from the source and associated with said unique identification information (ID).

In another embodiment, said jack audio comprises four contact terminals, one contact terminal being connected to a power input of the circuit, one other contact terminal being connected to a reference voltage input of the processing circuit and two contact terminals being connected to analog audio channel outputs of the circuit.

In another embodiment, said processing circuit is configured for receiving an encoded digital audio signal, decoding said digital audio signal and converting said digital audio signal into multichannel analog audio streams.

Consequently, object of this invention is a wireless device for receiving and forwarding an audio signal incorporating the features set out in the annexed claims, which are intended as an integral part of the present description.

### BRIEF DESCRIPTION OF THE DRAWINGS

Further objects, features and advantages of the present invention will become apparent from the following detailed description and from the annexed drawings, which are supplied by way of non-limiting example, wherein:

FIG. 1 is a schematic representation of an audio environment using a first embodiment of the wireless device according to the present invention; and

FIGS. 2a and 2b, represent in more details the inner configuration of the first embodiment of the wireless device according to the present invention.

### DETAILED DESCRIPTION OF THE PREFERRED EMBODIMENTS

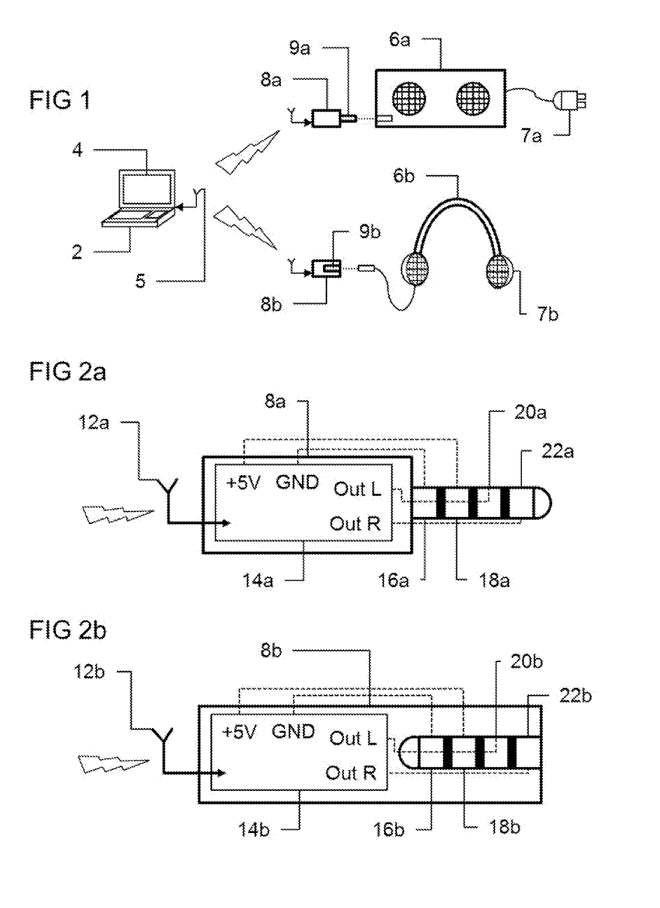

With reference to FIG. 1, a computer 2 has in its memory a plurality of audio files 4 encoded in a conventional digital format, such for example the so-called mp3 audio files. The computer 2 comprises an antenna 5 for transmitting and receiving data over a wireless interface. In this example described, this wireless interface is a Wi-Fi interface.

The system illustrated in FIG. 1 also comprises sound systems 6a and 6b. A first sound system 6a has sound emitting elements such as loud speakers and an audio jack socket (female) with a four-pin terminal. This first sound system 6a is also connected in a conventional manner to a power socket 7a. Referring to a second sound system 6b, a headset powered by batteries 7b is represented. The headset 6b comprises a cable with an audio jack plug (male) composed by a four pins terminal. Those four pins terminals are connected to sound emitting elements of the respective sound systems 6a and 6b and to the respective power sources 7a and 7b.

The system described with reference to FIG. 1 also comprises two wireless devices 8a and 8b according to the present invention, allowing to connect the computer 2 to the sound systems 6a and 6b.

A first wireless device 8a comprises a first jack audio 9a, in particular a four pins terminal male jack audio 9a corresponding to the female socket of the sound system 6a. Another wireless dongle 8b comprises a four pins terminal female jack audio 9b corresponding to the male plug of the sound system 6b.

A second wireless device 8b comprises a second jack audio 9b, in particular a four pins female socket corresponding to the male socket of the sound system 6a.

FIG. 2a represents the first wireless device 8a in more details. As illustrated in this figure, the first wireless device 8a comprises an antenna 12a for receiving wireless audio signals from the antenna 5 of the computer 2. The first wireless device 8a also comprises a circuit 14a for receiving and processing said received audio signal. This circuit 14a is adapted to receive a positive voltage (power) and a reference voltage (ground); moreover, said circuit 14a is also adapted to process a digital audio file and to output a stereo audio signal (Left and Right). For example the circuit 14a comprises a microcontroller (not shown in FIG. 2a) associated with a memory (not shown) for storing instructions and algorithms in order to convert an audio file into two analog signals corresponding to two different stereo channels with the appropriate digital to analog convertors, amplifiers and the like.

According to what is shown in FIG. 2a, the terminals 16a and 18a of the jack audio 9a are connected respectively to the power input (+5V) and to the ground input (GND) of the circuit 14a. The terminals 20a and 22a are connected to the stereo audio outputs (Out L, Out R) of the circuit 14a.

FIG. 2b represents the second wireless device 8b in more details.

Said second wireless device 8b comprises the same elements as the first wireless device 8a represented in FIG. 2a, with the exception of the fact that the jack audio 9a of the first wireless device 8a comprises a male connector, while the jack audio 9b of the second wireless device 8b comprises a female connector.

The earlier wiring described in connection with the first wireless device 8a is also valid for the second wireless device 8b. The terminals 16b and 18b of the jack audio 9b are connected respectively to the ground (GND) and power (+5V) inputs of the circuit 14b, while the terminals 20b and 22b are connected to the stereo audio outputs (Out L, Out R) of the circuit 14b.

When in operation, the wireless devices 8a and 8b are connected to the respective sound systems 6a and 6b. The circuits 14a and 14b receive electrical power from the power sources 7a and 7b or from said sound systems 6a and 6b by using terminals 16a and 18b of the jack audio 9a and terminals 16b and 18b of the jack audio 9b.

In this way, the wireless devices 8a and 8b are powered and their antennas 12a, 12b can detect radio signals transmitted from the source 2 (in the case showed in FIG. 1, said source 2 is represented as a computer) and establish a wireless connection between the source 2 and the sound systems 6a and 6b. The radio signals contain encoded audio files that are processed by the processing circuit 14a and 14b. The output of each of said circuits 14a and 14b is a stereophonic signal composed of two audio streams (left Out L and right Out R). Each of said audio streams is transferred to the corresponding sound system 6a, 6b using a different terminal 20a, 20b, 22a, 22b of the jacks audio 9a and 9b. The sound systems 6a, 6b output in a conventional manner a sound signal corresponding to the audio streams.

The wireless devices 8a, 8b of the present invention allow to connect any type of sound system equipped with at least a four-pin jack audio to a remote computer 2 using a wireless interface powered by the sound system 6a, 6b itself. The invention also allows broadcasting simultaneously an audio file to several sound systems 6a, 6b using the wireless connections.

In another embodiment of the wireless device 8a, 8b, the wireless interface is used to establish a duplex connection between the computer 2 and the sound systems 6a and 6b.

In comparison with the system described with reference to FIG. 1, FIG. 2a and FIG. 2b, in this embodiment the computer 2 is adapted to create several groups of audio files 4, or playlists. Furthermore the antenna 5 is adapted both for transmitting and receiving data over the wireless interface. Similarly, the antennas 12a and 12b and the circuits 14a and 14b of the wireless devices 8a and 8b are adapted for receiving and emitting data over the wireless interface.

Each of the wireless devices 8a and 8b further comprise a memory for storing a unique identification (ID) of the devices 8a, 8b.

As previously described with reference with the first embodiment, once the wireless devices 8a and 8b are connected to the sound systems 6a and 6b, they each receive electrical power from the respective sound system 6a, 6b and the processing circuit 14a and 14b are activated.

In this embodiment, during the establishment of the wireless connection, each wireless device 8a and 8b transmits to the computer 2 its unique ID. The manner in which the unique ID is transmitted to the computer 2 varies based on the actual wireless protocol used. In the example described, the unique ID is exchanged during the establishment of the Wi-Fi connection or in the so-called “handshake” phase, as a consequence of a request from the computer 2.

Once a wireless connection is established, the computer 2 is therefore able to separately identify each sound system 6a and 6b using the unique ID of the corresponding wireless device 8a and 8b.

Different playlists can then be transmitted simultaneously from the same source (in this case, a computer 2) to various sound systems 6a, 6b using the wireless devices 8a, 8b object of the present invention.

Advantageously, the invention can also comprise a circuit breaker (not shown in the drawings) integrated in either the wireless devices 8a, 8b or in the corresponding sound system 6a, 6b, to avoid creating a short circuit between the power source and the reference voltage while the jack audio of the wireless device 8a, 8b is being connected to the sound system 6a, 6b or in any case in which a three-terminal audio jack is used by mistake or in any other case of erroneous alignment.

In another embodiment of the invention, the jack audio 9a, 9b comprises more than four terminals such as a multichannel jack-audio (three-channel jack, etc).

Of course, the actual wireless interface can be any existing wireless interface such as Wi-Fi, Bluetooth, ZigBee or the like. Similarly, appropriate and conventional methods for avoiding interferences, of allocating the frequencies, managing the bandwidth, power saving or the like can be implemented between the wireless devices 8a, 8b and the audio sources 6a, 6b.

With reference to the second embodiment, unique ID of the wireless device 8a, 8b can be created using a specific formatting or can be created using an existing protocol such as the attribution of an IP address or a MAC address. For example, the audio files are encoded together with the unique ID information and broadcasted to several wireless devices. Only the wireless devices 8a, 8b with the corresponding unique ID will process the audio file.

The wireless device 8a, 8b of the invention can also comprise at least one diode as user interface for providing the user with information (such as, for example, success of failure of the establishment of the wireless connection).

In a different embodiment, the wireless device 8a, 8b of the invention uses an external antenna (instead of an internal antenna as previously described).

In another embodiment, the wireless device 8a, 8b has a plurality of interfaces jack audio 9a, 9b with at least two interfaces wherein the contact terminals or pins (left, right, ground and power) are arranged in a different order with respect to FIGS. 2a and 2b, so that it can be connected to various kinds of devices. Advantageously, the wireless device 8a, 8b may comprise several jack audio or interfaces 9a, 9b with the pins arranged in the same order to be simultaneously connected to several audio or sound systems.

The wireless device 8a, 8b can also have a combination of male plugs and female sockets.

Advantageously, the wireless device 8a, 8b according to the invention is configured to be automatically detected when using existing computer software.

It should be noted that the wireless device object of the present invention, allows using a terminal normally existing in a jack audio with four terminals, which is usually utilized for carrying audio signals coming from the microphone, as a contact element which can be used in an original way to provide electrical power to an external apparatus connected to the contact of the apparatus to which the wireless device is connected. This is possible due to the fact that the power voltage and the corresponding current have relatively low intensity, that do not require special contacts, also considering the fact that the technology used for physically manufacturing the terminals of the jacks audio is reliable enough to resist the voltage and current circulating through the electrical junctions.

The wireless device 8a, 8b, described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described wireless device, but may be subject to many modifications, improvements or replacements of equivalent parts and elements without departing from the inventive idea, as clearly specified in the following claims.

1. A wireless device (8a, 8b) for receiving and forwarding an audio signal comprising:
an antenna (12a, 12b) for receiving the audio signal from a source (2);
a circuit (14a, 14b) for receiving and processing said received audio signal;
a jack audio (9a, 9b) for providing said processed audio signal to a sound system (6a, 6b);
characterized in that said jack audio (9a, 9b) comprises at least one contact terminal (16a, 18a, 16b, 18b) configured for receiving electrical power from said sound system (6a, 6b) and to provide electrical power to said circuit (14a, 14b).

2. A wireless device (8a, 8b) according to claim 1, characterized in that it comprises a memory for storing a unique identification information (ID) and wherein said antenna (12a, 12b) and said circuit (14a, 14b) are further adapted for transmitting said unique identification information (ID) to said source (2).

3. A wireless device (8a, 8b) according to claim 2, characterized in that said circuit (14a, 14b) is further adapted for processing only audio signals received from the source (2) and associated with said unique identification information (ID).

4. A wireless device (8a, 8b) according to claim 1, characterized in that said jack audio (9a, 9b) comprises four contact terminals (16a, 18a, 20a, 22a; 16b, 18b, 20b, 22b), one (16a, 16b) of them being connected to a power input (+5V) of the circuit (14a, 14b), one other (18a, 18b) being connected to a reference voltage input of the circuit (14a, 14b) and the other two (20a,22a; 20b,22b) being connected to analog audio channel outputs (Out L, Out R) of the circuit (14a, 14b).

5. A wireless device (8a, 8b) according to claim 1, characterized in that said processing circuit (14a, 14b) is configured for receiving an encoded digital audio signal, decoding said digital audio signal and converting said digital audio signal into multichannel analog audio streams.

6. A wireless device (8a, 8b) according to claim 1, characterized in that it comprises an automatic circuit breaker adapted to avoid creating a short circuit between the power terminal and ground terminal.

7. A wireless device (8a, 8b) according to claim 1, characterized in that it comprises at least one diode as user interface for providing the user with information.

8. A wireless device (8a, 8b) according to claim 1, characterized in that it comprises a plurality of jack audio (9a, 9b).

9. A wireless device (8a, 8b) according to claim 1, characterized in that said at least one contact terminal (16a, 18a; 16b, 18b) comprises a first terminal (16a, 16b) connected to the ground input (GND) of the circuit (14a, 14b) and a second terminal (18a, 18b) connected to the power input (+5V) of the circuit (14a, 14b).
